(19) United States
(12) Patent Application Publication
(10) Pub. No.: US 2013/0157040 A1
(43) Pub. Date: Jun. 20, 2013

(54) SYSTEM AND METHOD FOR UTILIZATION OF SHROUDED PLASMA SPRAY OR SHROUDED LIQUID SUSPENSION INJECTION IN SUSPENSION PLASMA SPRAY PROCESSES

(71) Applicants: Christopher A. Petorak, Carmel, IN (US); Don J. Lemen, Indianapolis, IN (US); Albert Feuerstein, Carmel, IN (US); Thomas F. Lewis, III, Zionsville, IN (US); Mark McCoy, Indianapolis, IN (US)

(72) Inventors: Christopher A. Petorak, Carmel, IN (US); Don J. Lemen, Indianapolis, IN (US); Albert Feuerstein, Carmel, IN (US); Thomas F. Lewis, III, Zionsville, IN (US); Mark McCoy, Indianapolis, IN (US)

(21) Appl. No.: 13/715,189

(22) Filed: Dec. 14, 2012

Related U.S. Application Data
(60) Provisional application No. 61/570,503, filed on Dec. 14, 2011.
(60) Provisional application No. 61/570,525, filed on Dec. 14, 2011.

(51) Int. Cl. B05B 7/20; C23C 4/12

(52) U.S. Cl. CPC B05B 7/205; C23C 4/127
USPC 428/323; 427/446; 239/290

(57) ABSTRACT

A system and method for producing thermal spray coatings on a substrate from a liquid suspension is disclosed. The disclosed system and method include a thermal spray torch for generating a plasma and a liquid suspension delivery subsystem for delivering a flow of liquid suspension with sub-micron particles to the plasma to produce a plasma effluent. The liquid suspension delivery subsystem comprises an injector or nozzle which can produce an inert or reactive gas sheath partially or fully surrounding the plasma effluent. A sheath can also be used to isolate injection of the liquid suspension. A gas assist stream can also be employed at or near the suspension injection point. The shroud, sheath or gas assist technique can retain the sub-micron particles entrained within the plasma effluent and substantially prevent entrainment of ambient gases into the plasma effluent. The liquid suspension delivery subsystem can be arranged as an axial injection system, a radial internal injection system or an external radial injection system.

The present application claims priority from U.S. application Ser. No. 61/570,503, filed Dec. 14, 2011, which is incorporated by reference herein in its entirety, and U.S. application Ser. No. 61/570,525, filed Dec. 14, 2011, which is incorporated by reference herein in its entirety.

### FIELD OF THE INVENTION

The present invention relates to suspension plasma sprays, and more particularly to methods and systems for the shrouding, sheathing and/or shielding of suspension plasma spray effluents or liquid suspensions by an inert shroud, sheath and/or shield of gas.

### BACKGROUND

Conventional plasma spray technology primarily uses powder feeders to deliver powdered coating material into a plasma jet of a plasma spray gun. However, this technology is typically limited to the use of particles of at least +350 mesh (i.e., a median particle size of approximately of 45 microns in which 50 percent of particles are smaller than the median size and the other 50 percent of the particles are larger than the median size). As particle size decreases below +325 mesh, introducing powdered coating material directly into the plasma jet becomes progressively more difficult. Fine particles tend to pack tightly and agglomerate, increasing the likelihood of clogging in conventional powder feed systems.

In addition to clogging, conventional plasma spray technology is also ill-suited to the use of fine particles for other reasons. Because of the low mass of fine particles, combined with the extreme velocities of the plasma jet, fine particles tend to be deflected away from a boundary layer of the plasma jet without penetrating the boundary layer during radial injection. The velocity necessary for penetration of the fine coating particles is too large to physically be accomplished without disturbing the effluent itself. Practical limitations exist to increase velocity to this degree.

The need for coating finer particles is desired for use in thermal barrier coatings. The finer particles typically result in denser coatings and finer microstructural features, including for example, smaller lamellar splats and grains. The finer particles also tend to produce coated parts with improved microstructure. Fine particles are also easier to melt because of its large surface area relative to its small mass.

Suspension plasma spray (SPS) has emerged as a means for depositing finer particles. SPS is a relatively new advancement in plasma spray techniques which utilizes a liquid suspension of sub-micron size particles of the coating constituents or particulates materials, rather than a dry powder, as the coating media. The liquid serves as a carrier for the sub-micron size particles that would otherwise tend to agglomerate restricting or eliminating powder flow to the torch. The liquid also has been shown to function as a thermally activated solution that precipitates solids or reacts with suspended particles. Due primarily to the use of very small particles suspended in the liquid carrier, the suspension plasma spray process has demonstrated the ability to create unique coating microstructures with distinctive properties. The liquid droplets also provide the additional mass to impart the momentum necessary for entrainment by radial injection.

Notwithstanding the improvements of SPS over conventional plasma spray technology, current SPS systems and processes continue to suffer from a variety of drawbacks. For instance, conventional SPS typically produce coatings having uncontrolled microstructure grain size and/or lack of directional orientation growth, both of which can result in poor coating properties. To further compound the microstructural problem, adverse chemical reactions can occur between the substrate and the deposited coating materials.

Further, longer stand-off distances between the nozzle location and the deposition point may be required to adequately coat complicated geometries such as turbine blades. However, the longer stand-off distances may provide the coating constituents excessive dwell or residence time, thereby causing cooling and resolidifcation of coating constituents prior to reaching the substrate. Reducing the stand-off distance can cause insufficient heating such that the particulates are never able to absorb enough heat and fully melt. In both cases, the end result is lack of particulate adhesion to the substrate, thereby reducing deposition efficiency of the material. The finer particulate size of the coating constituents have increased surface areas that can rapidly heat up and cool down at faster rates than typically encountered in standard plasma technology. Accordingly, the increased surface area of the finer particulates creates unprecedented challenges to optimizing the correct stand-off distance.

Still further, turbulent flow of the plasma gas effluent emerges from the nozzle of the torch. The turbulent interaction of the plasma effluent with the atmosphere imparts rapid decreases in effluent temperature and rapid directional flow changes that result in the ejection of the coating particulates from the flow path directed to the substrate. As a result, the ejected particulates result in decreased deposition efficiency.

The above problems are only a few examples of the types of new challenges posed by the utilization of SPS systems and processes to deposit ever increasingly finer coating media constituents. In view on the on-going challenges, there is a need to improve upon the current suspension plasma spray processes and systems.

### SUMMARY OF THE INVENTION

As described in more detail below, the present embodiments of the invention addresses some of the disadvantages and provides techniques to control the aforementioned interactions through use of an inert gas shroud surrounding the plasma effluent stream and liquid suspension contained therein (collectively, referred to as “effluent,” or “plasma effluent” herein and throughout the specification). The present invention uniquely combines an inert gas shroud with a plasma spray process using submicron particles delivered via liquid suspension to improve current suspension plasma spray capabilities and create new coating microstructure possibilities through controlling the suspension injection and fragmentation as well as the interactions between the effluent and suspensions.

The invention may include any of the following aspects in various combinations and may also include any other aspect described below in the written description or in the attached drawings.

The present invention may be characterized as a thermal spray system for producing coatings on a substrate from a liquid suspension comprising: a thermal spray torch for generating a plasma effluent; a liquid suspension delivery subsystem for delivering a flow of liquid suspension with sub-micron particles dispersed therein to the plasma effluent; and a nozzle assembly for delivering the plasma effluent from the thermal spray torch and adapted for producing an inert gas shroud substantially surrounding said plasma effluent; wherein the shroud is configured to substantially retain entrainment of the sub-micron particles in the liquid suspension and substantially inhibit gases from entering and reacting with the plasma effluent.

The present invention may also be characterized as a method of producing coatings on a substrate using a liquid suspension with sub-micron particles dispersed therein, the method comprising the steps of: generating a plasma from a thermal spray torch; delivering a flow of liquid suspension with sub-micron particles dispersed therein to the plasma or in close proximity thereto to produce an effluent stream; surrounding the flow of the effluent stream with an inert gas shroud to produce a shrouded effluent; retaining the sub-micron particles entrained within the shrouded effluent; and directing the shrouded effluent with the sub-micron particles contained therein towards the substrate to coat the substrate.

### BRIEF DESCRIPTION OF THE DRAWINGS

The above and other aspects, features, and advantages of the present invention will be more apparent from the following, more detailed description thereof, presented in conjunction with the following drawings, wherein:

FIG. 1 is a schematic illustration of a prior art suspension plasma spray process employing an axial injection of the liquid suspension;

FIG. 2 is a schematic illustration of a prior art suspension plasma spray process employing an internal radial injection of the liquid suspension;

FIG. 3 is a schematic illustration of a prior art suspension plasma spray process employing an external radial injection of the liquid suspension;

FIG. 4 is a schematic illustration of an extended shroud suspension plasma spray process employing an axial injection of the liquid suspension in accordance with an embodiment of the present invention;

FIG. 5 is a schematic illustration of an extended shroud suspension plasma spray process employing an internal radial injection of the liquid suspension in accordance with another embodiment of the present invention;

FIG. 6 is a schematic illustration of an extended shroud suspension plasma spray process employing an external radial injection of the liquid suspension in accordance with yet another embodiment of the present invention;

FIG. 7 is a schematic illustration of a partial shroud suspension plasma spray process where the flow characteristics of the shroud are controlled to allow atmospheric infiltration and suspension evaporation to optimize the combustion process occurring within the effluent stream;

FIG. 8 shows yet another embodiment of the present invention employing a diverging inert gas shroud;

FIG. 9 shows yet another embodiment of the present invention employing a converging inert gas shroud;

FIG. 10 is a schematic illustration of an suspension plasma spray process employing a gas shrouded or gas sheathed axial injection of the liquid suspension in accordance with an embodiment of the present invention;

FIG. 11 is a schematic illustration of a suspension plasma spray process employing a gas shrouded or gas sheathed internal radial injection of the liquid suspension in accordance with another embodiment of the present invention;

FIG. 12 is a schematic illustration of a suspension plasma spray process employing a gas shrouded or gas sheathed external radial injection of the liquid suspension in accordance with yet another embodiment of the present invention; and

FIG. 13 is a schematic illustration of a suspension plasma spray process employing an external radial injection of the liquid suspension with a gas assist at or near the injection point in accordance with yet another embodiment of the present invention.

### DETAILED DESCRIPTION

The present disclosure relates to a novel SPS system and process for the deposition of coating material. The SPS system and process of the present invention is particularly suitable for deposition of sub-micron particles. The disclosure is set out herein in various embodiments and with reference to various aspects and features of the invention.

The relationship and functioning of the various elements of this invention are better understood by the following detailed description. The detailed description contemplates the features, aspects and embodiments in various permutations and combinations, as being within the scope of the disclosure. The disclosure may therefore be specified as comprising, consisting or consisting essentially of, any of such combinations and permutations of these specific features, aspects, and embodiments, or a selected one or ones thereof.

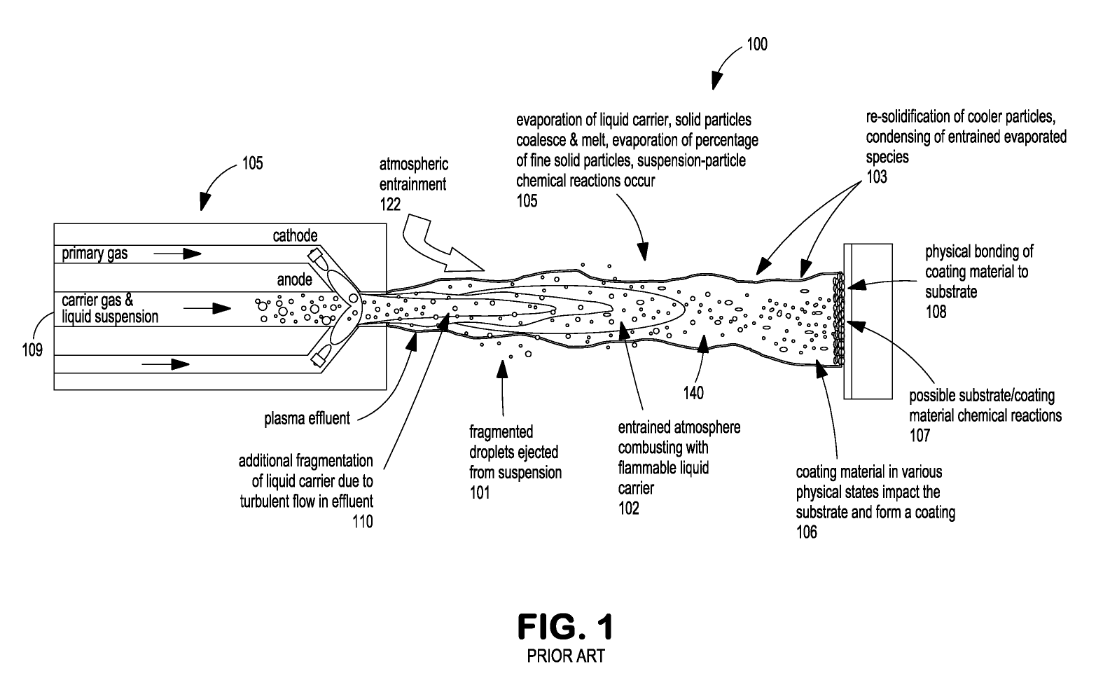

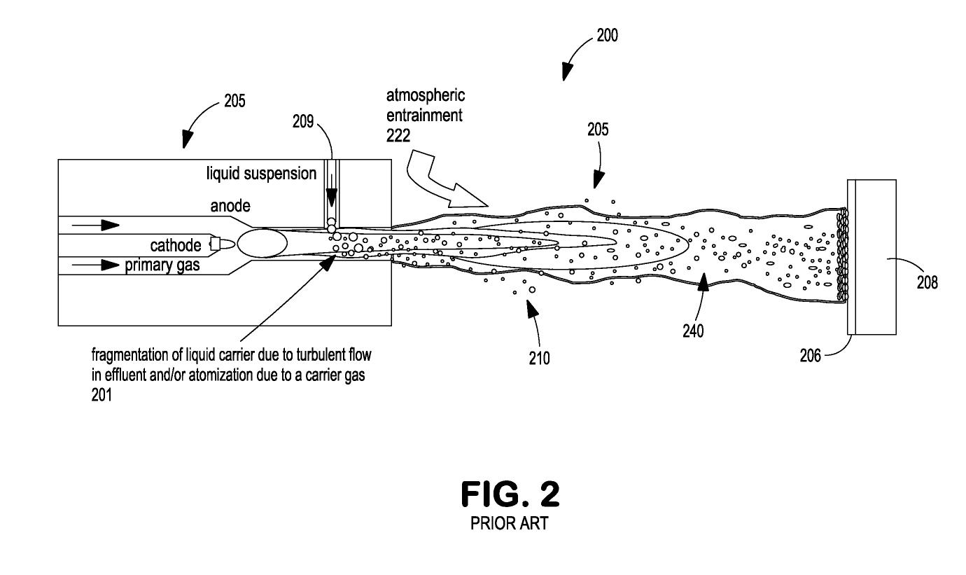

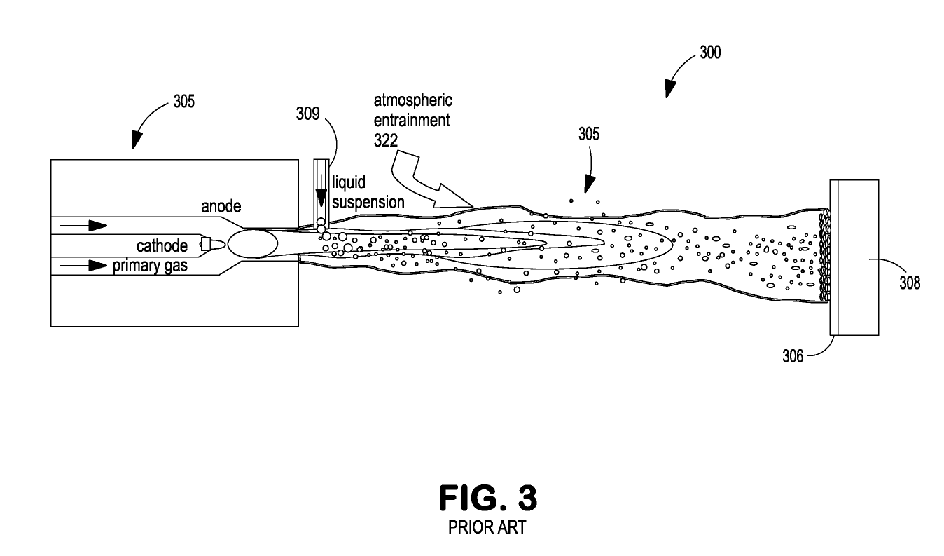

The present invention recognizes the shortcomings of current SPS systems and processes. These shortcomings can be better identified by referring to FIGS. 1-3. FIGS. 1-3 show several schematic illustrations of prior art suspension plasma spray systems and processes 100, 200 and 300 employing an axial injection of the liquid suspension; internal radial injection of the liquid suspension and external radial injection of the liquid suspension, respectively. In each of these prior art systems, numerous physical and chemical interactions are occurring, many of which are uncontrolled. For example, FIGS. 1 and 2 show fragmentation of the liquid carrier occurs at regions 110 and 201 in an undesirable random-like manner due to the turbulent flow in the effluent. The fragmentation occurs soon after the plasma effluent and liquid suspension are in contact. As used herein, the term “effluent” and “plasma effluent” will be used interchangeably and are intended to refer to any combination of the plasma gas, coating constituents or particles and liquid carrier, each of which is flowing from the outlet of a torch nozzle. For example, at the immediate outlet of each of nozzles 105, 205 and 305 of their respective torches, the effluent 140, 240 and 340 will more than likely consist of plasma (i.e., hot carrier gas ionized by virtue of being exposed to an arc generated between the cathode and anode) and droplets of liquid carrier containing coating particles (i.e., liquid suspension 109, 209 and 309). However, within the vicinity of the substrate 108, 208 and 308, the effluent 140, 240 and 340 will primarily consist of the coating particulates and a potentially significantly cooler effluent 140, 240 and 340, as substantially all of the liquid carrier has evaporated by this stage of the SPS coating process 100, 200 and 300.

FIGS. 1 and 2 also show a portion of the fragmented droplets of the liquid suspension 109 and 209 are ejected from the effluent 140 and 240 at regions 110 and 210, respectively.

FIGS. 1-3 further show atmospheric entrainment 122, 222 and 322 into the plasma effluent 140, 240 and 340 in a region that is in close proximity to the outlet of the torch nozzle 105, 205 and 305. The infiltration of atmospheric gases, including oxygen, results in accelerated combustion of the entrained atmosphere with flammable liquid carriers (e.g., ethanol). In addition, FIG. 1 shows there is evaporation of the liquid carrier, as shown by representative region 105, causing many of the sub-micron solid particles to coalesce and melt. Where ideal thermal conditions within the effluent 140, 240 and 340 exist, a percentage of the sub-micron or very fine particles transform into an evaporative species, thereby resulting in lowered deposition efficiency and inadequate coating of the substrate 108, 208 and 308.

These fragmented droplets, melted particles and evaporated species of the suspension 109, 209 and 309 along with the combustion by-products resulting from atmospheric entrainment are carried along the effluent stream 140, 240 and 340 towards the substrate 108, 208 and 308, during which time additional suspension-particle chemical reactions occur including unwanted reactions such as particle oxidation, as depicted at regions 105, 205 and 305. Also during the transit of the effluent 140, 240 and 340, many fragmented droplets and particles continue to be ejected from the suspension 109, 209 and 309, thereby further lowering deposition efficiency.

FIGS. 1-3 further show that as the effluent stream 140, 240 and 340 approaches the substrate 108, 208 and 308 to be coated, the temperature profile within the effluent stream 140, 240 and 340 changes resulting in some re-solidification of cooler particles and condensing of entrained evaporated species. Upon reaching the substrate 108, 208 and 308, the coating material in the various physical states impact the substrate and form a coating 106, 206 and 306, including the physical bonding of coating material to the substrate. Adverse chemical reactions between the substrate 108, 208 and 308 and the coating materials can occur.

Current suspension plasma spray systems suffer from the disadvantage of not adequately controlling these physical and chemical interactions during the three key phases of the suspension plasma spray process, namely: (i) suspension injection and fragmentation; (ii) effluent and suspension interactions; and (iii) substrate interactions with effluent and coating buildup.

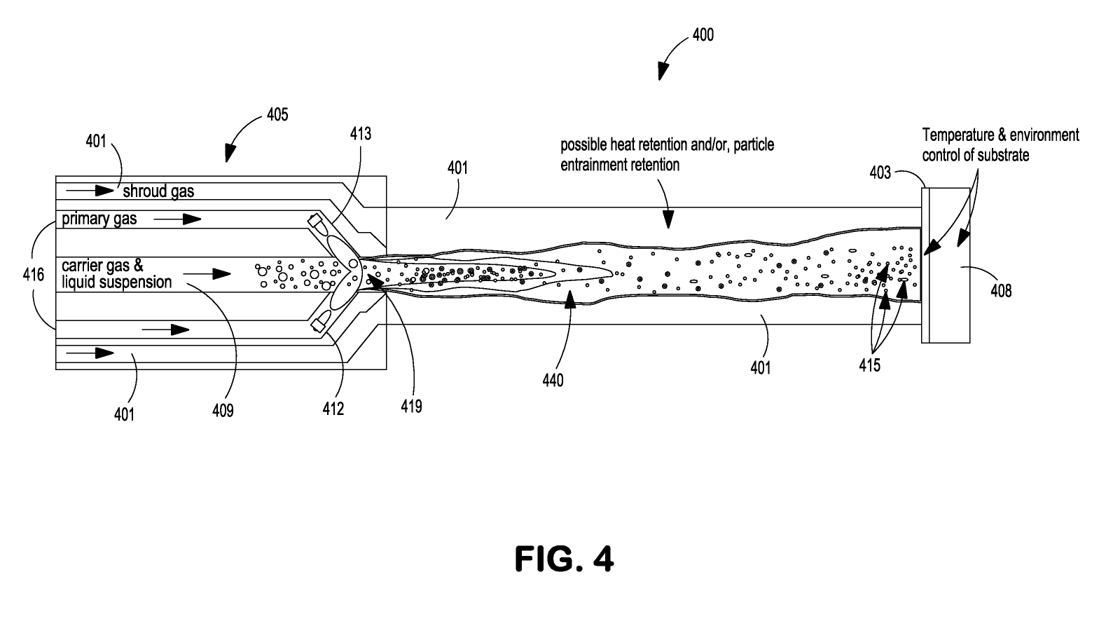

As will be discussed in FIGS. 4-13, the present embodiments of the invention address many of the aforementioned disadvantages shown in FIGS. 1-3. The present invention provides techniques to control the aforementioned adverse interactions through use of an inert gas shroud, sheath and/or gas assist surrounding the effluent stream and/or injection location for liquid suspension.

Turning now to FIGS. 4 through 6, there are shown schematic illustrations of different embodiments of the present invention, namely depictions of suspension plasma spray systems and processes 400, 500 and 600, respectively. SPS system and process 400 employs an axial injection of the liquid suspension 409 with an extended inert gas shroud 401 surrounding the effluent 440 (i.e., plasma and liquid suspension 409). Any suitable inert gas may be used to create the shroud 401, such as, for example, argon, nitrogen, and/or helium. FIG. 4 shows that the shroud 401 is created by flowing inert gas at a predetermined flow rate through an outer nozzle that surrounds an inner nozzle through which the liquid suspension 409 and carrier gas 416 can sequentially or co-flow relative to each other. The shroud 401 is oriented around the flow of effluent 402, thereby forming a protective envelope of inert gas around the effluent 440. FIG. 4 shows that the shroud 401 extends from within the nozzle 405 of the torch to the substrate surface 408.

Prior to the liquid suspension 409 emerging from the outlet of nozzle 405, a plasma 419 is created as primary torch gas 416 flows between a cathode 412 and anode 413 into a region where an arc is generated. The carrier gas 416 is shown sequentially flowing or co-flowing with the liquid suspension 409 through the center of the nozzle 405. An arc is generated between the cathode 412 and anode 413. The primary torch gas 416 passes through the arc region and ionizes into a hot plasma 419 of gaseous ions and/or radicals within the nozzle 405. The plasma 419 provides the thermal energy source required to evaporate the liquid carrier and melt the coating constituents 415 of liquid suspension 409. The plasma 419 also provides the energy source to provide sufficient momentum to accelerate the coating constituents or particles 415 towards the substrate surface 408.

After the plasma 419 is created, the liquid suspension 409 (i.e., liquid carrier droplets with coating constituents 415 contained therein) and plasma 419 emerge from the outlet of the nozzle 405 as an effluent 440. The shrouded gas 401 converges within a throat section of the nozzle 405 and thereafter emerges from the nozzle 405. It should be understood that the terms “shroud” and “shrouded gas” have the same meaning and will be used herein and throughout the specification interchangeably.

The shroud 401 is configured to flow at a sufficient flow rate relative to that of the effluent 440 so as to form a continuous envelop about the effluent 440. The effluent 440 is characterized as having a trajectory or flow path of the liquid suspension 409 defined, at least in part, from the outlet of the nozzle 405 to the substrate surface 408, whereby the flow path is partially or fully enveloped by the shroud 401. As shown in the embodiment of FIG. 4, the length of the shroud 401 extends from the outlet of the nozzle 405 to the substrate surface 408. The continuous envelope of the shroud 401 creates a thermal envelope that acts as an effective insulator to retain heat in the effluent stream 440 across longer flow path distances from the outlet of the nozzle 405 to the surface of the substrate 408. The controlled temperature from the outlet of the torch 405 to the substrate 408 enables evaporation of the liquid carrier of the liquid suspension 409. After evaporation of the liquid carrier, the heat used to evaporate the liquid carrier is now realized by the coating constituents 415 generally contained within the droplets of the liquid suspension 409, which are now free floating and travelling towards the substrate surface 408. The coating constituents 415 partially or substantially melt without undergoing significant cool down as they flow towards the surface of the substrate 408. The molten coating constituents 415 impact the substrate surface 408 to deposit as a coating 403. In this manner, the improved thermal envelope therefore improves deposition efficiency. Further, the retention of heat within the effluent 440 creates improved uniformity in temperature distribution that can decrease stand-off working sensitivity. As such, the present invention as shown in the embodiment of FIG. 4 allows a unique SPS system and process 400 for coating complicated geometries at father stand-off distances than previously attainable with conventional SPS, without incurring substantial solidification of the coating constituents 415 as they impact the substrate surface 408.

The shroud 401, by virtue of its shield-like properties, can also provide the added benefit of minimizing or substantially eliminating the oxidation of the coating particles suspended in the effluent 402. The shroud 401 prevents or inhibits effluent 402 interactions with the surrounding atmosphere. In this manner, the adverse reactions observed along the flow path in FIGS. 1-3 are eliminated.

The shroud 401 also counteracts any tendency for droplets of the liquid suspension 409 to eject from the effluent 440. Generally speaking, in the absence of the shroud 401, the effluent 440 is in a turbulent flow regime which may be sufficient to break up liquid droplets into smaller droplets, and in the process of doing so, undesirably impart excessive momentum to at least some of the droplets to eject them from the effluent stream 440. Employing the shroud 401 can facilitate the retention of the droplets of the liquid suspension 409 and coating constituents 415 within the effluent 440. As a result, increased utilization of the coating constituents 415 is attained.

The combination of the aforementioned process benefits can produce a coating 403 deposited onto the substrate surface 408 having a microstructure with grain orientation and sufficiently small particle size distribution. The favorable microstructural possibilities are controllable and reproducible by virtue of the innovative SPS system and process 400.

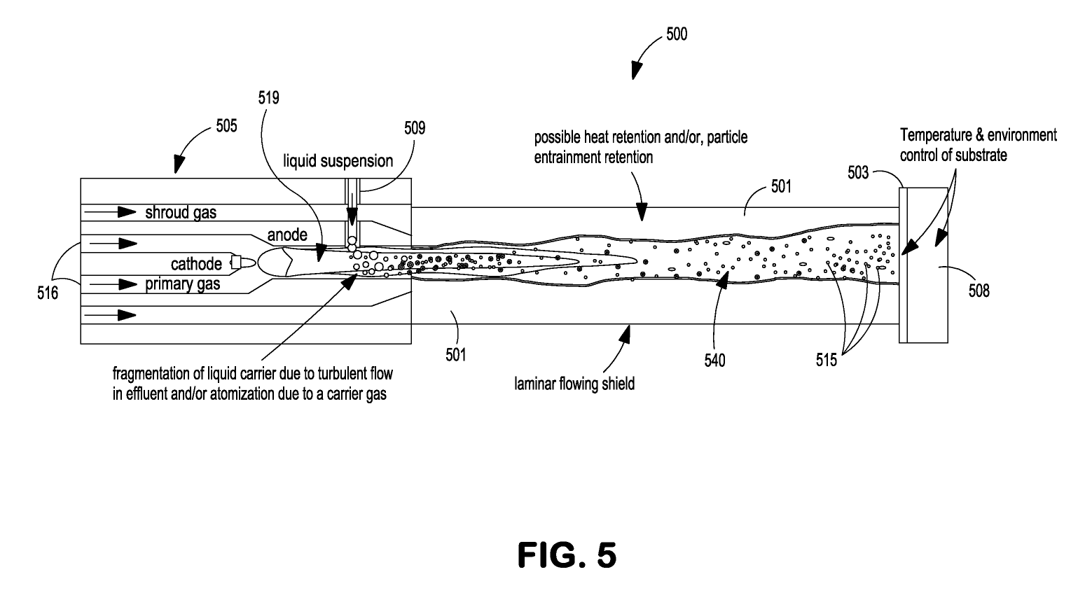

In accordance with another embodiment of the present invention, FIG. 5 shows an SPS system and process 500 in which the liquid suspension 509 is internally injected within the torch nozzle 505. The internal injection of the liquid suspension 509 can occur in a substantially radial direction at an orthogonal orientation with respect to the axis of the plasma 519 that is generated within the nozzle 505. It should be understood that the angle of injection of the liquid suspension 509 relative to the plasma 519 may be varied.

FIG. 5 shows that the primary or carrier gas 516 passes through the arc region and ionizes into a hot plasma state 519 of gaseous ions within the nozzle 505. It should be understood that injection of suspension 509 can occur downstream of the plasma 519 within the anode, which may represent a region where the torch gas 516 has cooled down from the plasma state to a superheated gas. The turbulent flow of the plasma 519 fragments and/or atomizes the liquid carrier droplets of suspension 509 within the nozzle 505 and also at the outlet of the nozzle 505.

As shown in the embodiment of FIG. 5, the length of the shroud 501 extends from the outlet of the nozzle 505 to the substrate surface 508. The shroud 501 provides heat retention to create a continuous thermal envelope and also prevents ejection of the droplets of suspension 509 from the effluent 540. The embodiment of FIG. 5 shows that the shrouded gas 501 is configured to flow in a laminar flow rate regime. The controlled and lowered velocity of the laminar flowing shroud 501 can enable the fragmentation phenomena of the droplets of the liquid suspension 509 across the shroud 501 to occur in a more controlled manner compared to conventional SPS systems and processes 100, 200 and 300 of FIGS. 1-3. The fragmented droplets of liquid suspension 509 therefore attain an improved uniformity in size distribution. As a result, the coating constituents 515 deposit on the substrate surface 508 to form a coating 503 having a more controlled particle size distribution. It should be understood that certain coating applications may not require substantial fragmentation of the droplets of liquid suspension 509. As such, in another embodiment of the present invention, the shroud 501 can be configured to not fragment the droplets yet still achieve the other benefits of utilizing a shroud 501 that have been mentioned above.

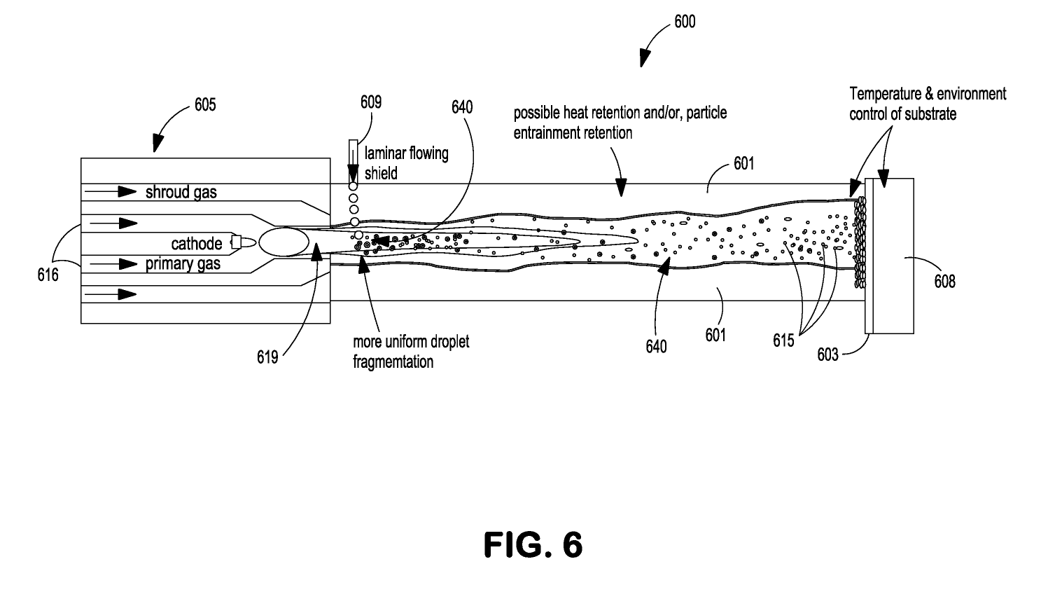

Other injection locations of the liquid suspension are contemplated in accordance with the principles of the present invention. For instance, FIG. 6 shows an SPS system and process 600 in which the liquid suspension 609 is injected externally to the torch nozzle 605. The external injection of the liquid suspension 609 can occur in a substantially radial direction at an orthogonal orientation with respect to the axis of the plasma effluent 640. It should be understood that the angle of injection of the liquid suspension 609 relative to the plasma effluent 640 may be varied. Similar to FIG. 5, the shrouded gas 601 is configured to flow in a laminar flow rate regime to produce more uniform fragmentation of the droplets of the liquid suspension 609.

Each of the embodiments of FIGS. 4, 5 and 6 offer unique process benefits. For example, through use of various inert gas shrouds 401, 501 and 601 described in the embodiments of FIGS. 4, 5 and 6, the plasma and liquid suspension interaction can be more precisely controlled. In particular, the inert gas shroud 401, 501 and 601 can be used to control the heat retention and particle entrainment retention within the effluent stream 440, 540 and 640, and thus more precisely control the chemical and physical reactions occurring between the plasma effluent-liquid carrier and coating constituents 415, 515 and 615, including more control of the evaporation of the liquid carrier along the flow path of the effluent 440, 540 and 640. Combustion reactions are eliminated as the shrouds 401, 501 and 601 provide a substantially chemically inert blanket or envelope about the effluent 440, 540 and 640 that prevents atmospheric entrainment. Additionally, employing a gas shroud 401, 501 and 601 can also provide kinetic energy at the boundaries of the effluents 440, 540 and 640 to aid in re-entraining coating particles 415, 515 and 615 which may have been ejected from the effluent 440, 540 and 640 due to turbulent flow within the effluent 440, 540 and 640.

Furthermore, each of the embodiments shown in FIGS. 4, 5 and 6 creates an inert gas shroud around the plasma effluent that operates to retain more heat in the effluent and provide a larger operation envelope. The larger operational envelope translates to longer working distances between torch and substrate as well as better treatment of the sub-micron particles. In other words, the sub-micron particles are at the prescribed temperature for longer residence times resulting in improved melting and an increase in evaporative species of the particles within the plasma effluent. This can result in decreased sensitivity to stand-off distances. In addition, use of the inert gas shroud may also contribute to more uniform droplet fragmentation as well as more control of the environment and temperature near and at the substrate surface.

The process benefits, some of which have been mentioned above, can translate into more controlled microstructures of deposited coatings 403, 503 and 603. The present invention recognizes that parameters which determine the microstructure and properties of the coatings include the temperature, size and velocity of the coating constituents or particles and the extent to which the particles have reacted with or exposed to the surrounding environment during deposition. In the present invention, the shroud 401, 501 and 601 can retain heat and create a more uniform temperature and controlled temperature distribution as the coating particles impact the substrate surface. Additionally, the laminar flow gas shrouds 501 and 601 as shown and described in FIGS. 5 and 6 can help create more uniformly fragmented coating particles 515 and 615. Still further, the shroud 401, 501 and 601 creates a chemically inert barrier that prevents oxidation of the coating particles. The shrouded effluent therefore creates an improved microstructure.

Additional factors impacting the microstructure and properties of the deposited coatings include the rate of deposition, angle of impact, and substrate properties, each of which can be controlled to a greater degree, by virtue of the shroud. Since the coating constituents or particles are heated and accelerated by the gaseous effluent of the plasma, the temperature and velocity of the coating particles are a function of the physical and thermal characteristics of the effluent stream and the standoff distance between the exit of the plasma spray device and the substrate. By controlling the properties of the effluent stream by use of the shroud, the temperature and velocity of the coating particles can be controlled with greater precision to improve coating adhesion and coating microstructure.

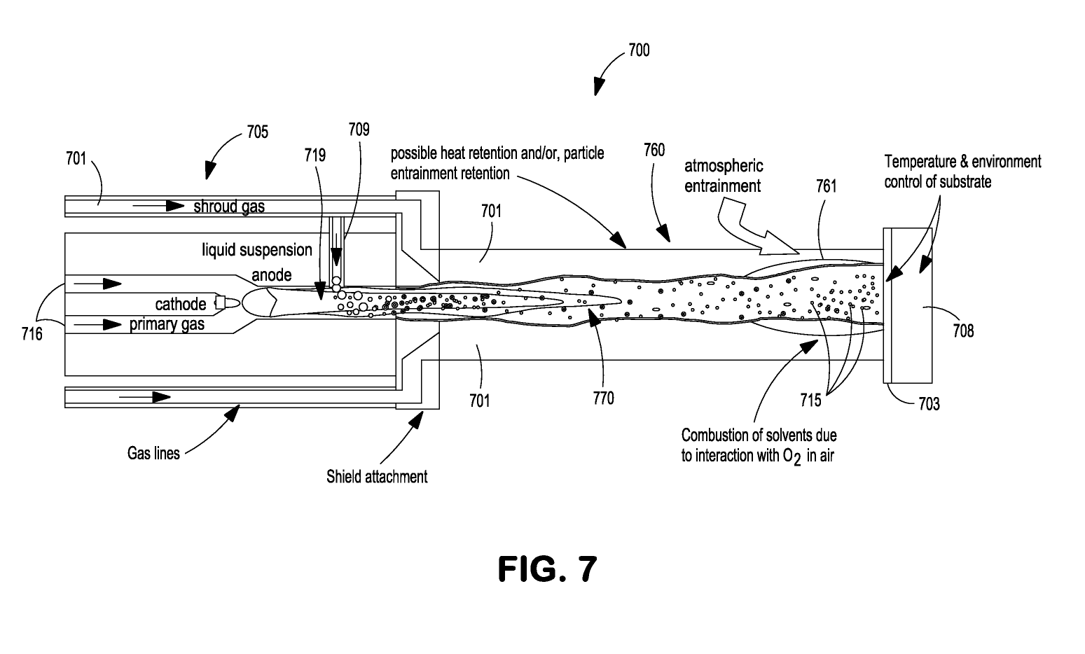

The present invention contemplates various other design variations of the inert shroud employed herein. For example, FIG. 7 is a schematic illustration of another embodiment of the present invention, namely a suspension plasma spray system and process 700 employing a partially extended inert gas shroud 701 surrounding the effluent 770. In particular, FIG. 7 shows that the shrouded gas 701 envelopes the effluent 770 from the outlet of the nozzle 705 to approximately region 760. Region 760 and downstream thereof, as indicated by regions 761, is representative of an absence of shroud 701 to intentionally entrain atmospheric gases into the effluent 770. The absence of the shroud beginning at region 760 enables combustion of solvents due to infiltration and reaction with oxygen from atmospheric air. Such a process design may be desirable when depositing coatings which require oxygen enrichment. The exact manner in which the shroud 701 can only partially extend along the flow path of the effluent 770 can occur in several ways. In one example, the flow rate of the inert gas shroud 701 can be decreased relative to that of the effluent 770 (i.e., plasma in combination with the liquid suspension) so as to diminish the shrouding effects of the effluent 770 towards the substrate surface 708. In this manner, the resultant coating 703 will be at least partially oxidized.

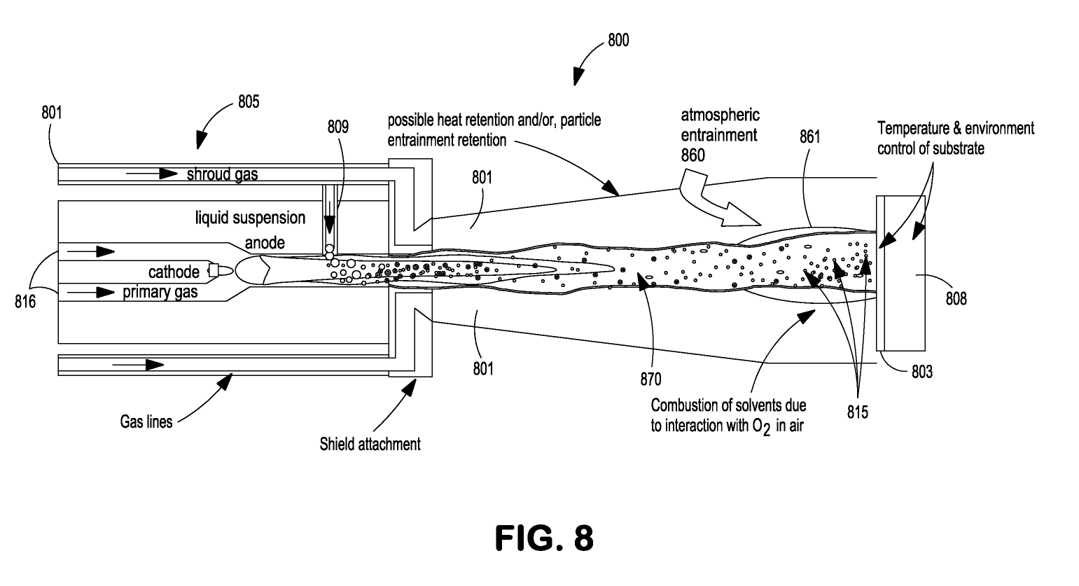

FIG. 8 shows another variation of a suspension plasma spray system and process 800 employing a partially extended inert gas shroud 801. FIG. 8 employs a divergent inert gas shroud 801. The shrouding effects in FIG. 8 are shown to gradually taper off or lessen in a divergent manner at a predetermined axial distance from the outlet of nozzle 805. In comparison to the inert gas shroud 701 of FIG. 7, the divergent inert gas shroud 801 is adapted to facilitate additional atmospheric infiltration into the effluent stream 870. Region 860 and downstream regions 861 indicate a complete absence of the shroud 801 to allow complete atmospheric entrainment of effluent stream 870. In this manner, the coating particulates 815 and resultant coating 803 will be oxidized.

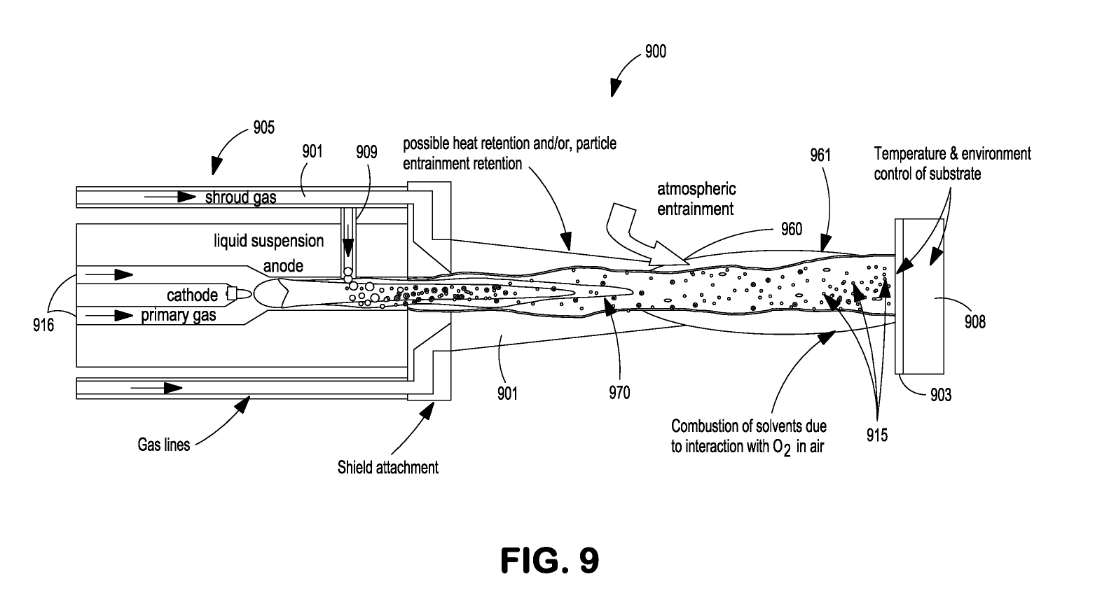

FIG. 9 shows yet another embodiment employing a converging inert gas shroud 901 adapted to facilitate full combustion of flammable species of the liquid carriers of effluent 970 proximate the nozzle 905 while inhibiting the loss or ejection of coating particles 915 from the effluent 970. Shrouding effects are intended to be substantially or completely eliminated at region 960 and downstream thereof, as indicated by regions 961.

It should be appreciated that the use of partial inert gas shrouds 701 depicted in FIG. 7, as well as the divergent or convergent inert gas shrouds 801 and 901 surrounding their respective effluent streams 870 and 970, as depicted in FIGS. 8 and 9, can be equally applied to suspension plasma spray systems utilizing internal radial injection configurations, external radial injection configurations and axial injection configurations.

As applied to suspension plasma sprays, the use of inert gas shrouds, and more particularly, the control of flow characteristics of the inert gas shrouds surrounding the effluent, can be used to prevent or control the degree and/or the location of atmospheric mixing with the effluent stream and control the degree or location of the combustion processes occurring within the effluent stream. As such, the present invention offers a unique means for controlling process variables and, as a result, attaining a more controlled coating microstructure.

Typical inert gases used for the shroud include, nitrogen, argon, and helium or combinations thereof may be used. The most likely flow characteristics of the inert gas shroud to be controlled include the volumetric flow rate and velocity of the inert gas as well as the degree of turbulence and dispersion characteristics of the inert gas shroud. Many of these flow characteristics are dictated by the geometry and configuration of the nozzle used to form the inert gas shroud as well as the inert gas supply pressures and temperatures.

The shrouded plasma effluents described above are part of a unique SPS system and process offering a multitude of process benefits. By way of example, and not intending to be limiting in any manner, the shrouded plasma effluents can decrease coating sensitivity to changes in stand-off associated with fast heating and cooling rates seen with finer sub-micron particles, as a result of creating a large operational thermal envelope. Furthermore, the shrouded plasma effluents offer the ability to delay the introduction of atmospheric air which can serve to rapidly cool the coating constituents prior to deposition. The shrouds may also resist particles within the effluent from ejecting due to the turbulence of the effluent stream. Still further, the shroud can assist in penetrating the liquid suspension into the effluent to enable the finer droplets of the liquid suspension to be exposed to higher temperature treatments, thereby enabling improved thermal treatment. A partial shrouded plasma effluent as shown in FIGS. 7-9 can be employed to introduce oxygen at a predetermined location along the flow path trajectory of the coating particles for the purpose of supplementing energy into the effluent through combustion of the solvent. This might be a viable option when deposition rates and efficiencies are well below 50% as a result of a large percentage of the energy in the effluent being utilized to evaporate the liquid carrier.

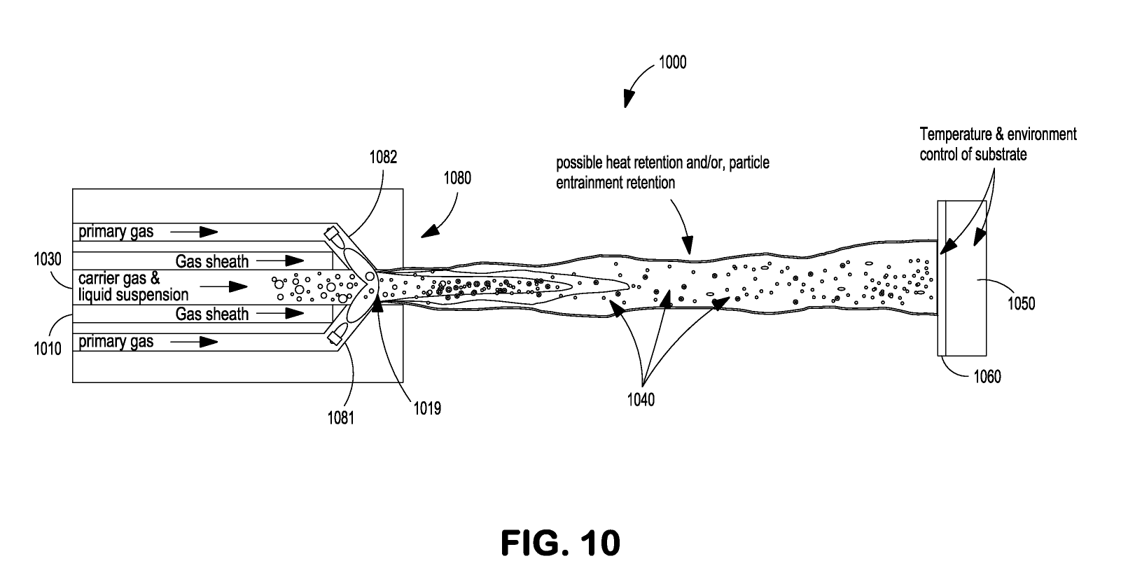

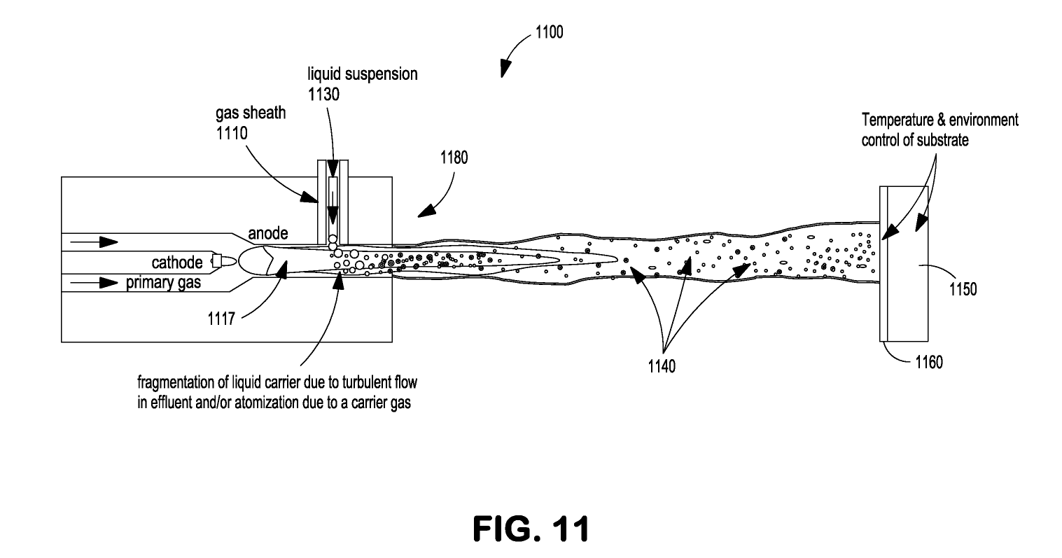

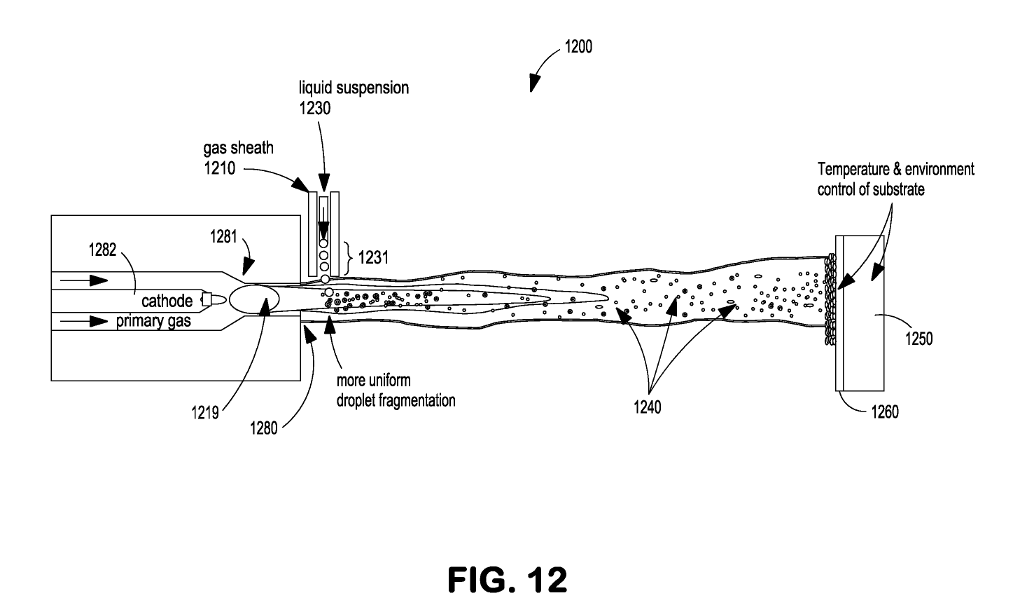

As an alternative to or in addition to partially or fully shrouding the effluent, as has been described to this point in connection with FIGS. 1-9, the concept of shrouding may also be extended to isolating injection of the liquid suspension with a sheath. Turning now to FIGS. 10-13, schematic illustrations of different embodiments of suspension plasma spray systems and processes 10000, 1100 and 1200 employing a gas shrouded or sheathed axial injection of the liquid suspension (FIG. 10); a gas shrouded or sheathed internal radial injection of the liquid suspension (FIG. 11); and a gas shrouded or sheathed external radial injection of the liquid suspension, (FIG. 12), respectively.

FIG. 10 shows a suspension plasma system and process 1000 in which a gas sheath 1010 envelopes the carrier gas with liquid suspension 1030 within the nozzle 1080. The gas sheath 1030 axially extends around the liquid suspension 1030. The gas sheath 1030 preferably has a laminar flow. The sheath 1030 extends approximately to the point at which the plasma 1019 is formed (i.e., the location at which the primary torch gas ionizes as it passes through the arc generated by the cathode 1081 and anode 1082). While not wishing to be bound by any particular theory, it is believed that utilizing a laminar flow gas shroud or gas sheath 1010 along the axial injection of the suspension 1030 improves the injection and entrainment of submicron powders into the plasma effluent 1040 by reducing local turbulence of the suspension injection flow, particularly at the point where the plasma 1019 is created. Furthermore, the submicron particles in the liquid suspension 1030 are susceptible to directional changes in flow as their decreased mass provides less resistance to changes in momentum from outside forces as the effluent 1040 encounters atmospheric air as shown in FIG. 10. The gas sheath or gas shroud 1010 type device can provide a more laminar type flow along or near the point of injection that can sufficiently reduce or inhibit atmospheric interference with the suspension injection as the suspension 1030 emerges from the outlet of the nozzle 1080. This can ensure a more effective and consistent suspension injection into the plasma effluent 1040. By not being susceptible to particle ejection, the effluent 1040 upon emerging from the outlet of the nozzle 1080 can maintain a flow path trajectory directed towards the surface of the substrate 1050 where it deposits as coating 1060. Furthermore, the gas sheath 1010 may provide sufficient heat retention of the plasma effluent 1040 as it flows towards the substrate 1050.

In an alternative gas sheath embodiment, FIG. 11 shows a SPS system and process 1100 in which a gas sheath 1110 envelopes the liquid suspension 1130. The gas sheath 1110 radially extends around the injection location of liquid suspension 1130 at a location within the nozzle 1180. Primary torch gas 1120 axially flows within the nozzle 1180 and ionizes into a plasma 1119 when it contacts an arc generated by cathode 1182 and anode 1181. FIG. 11 depicts that the liquid suspension 1130 is radially injected into the plasma within the nozzle 1180. The injection occurs at an orthogonal orientation with respect to the axis of the plasma 1119. However, it should be understood that the angle of injection of the liquid suspension 1130 relative to the plasma 1119 may be varied as contemplated by the present invention.

The present invention recognizes that that the sub-micron size of the particles may be too small in size to have sufficient momentum to penetrate into the plasma, which generally represents a region of high turbulence. The gas sheath 1110 can provide the liquid suspension 1130 the necessary momentum to be injected into the plasma. The sheath 1110 therefore can allow independent control of radial injection without having to increase, for example, the velocity of the liquid suspension 1130. In other words, the absence of the sheath 1110 would likely require increasing the velocity of the suspension 1130 at the injection location. Increasing the injection velocity may result in too high of a mass flow rate, which can adversely affect thermal treatment of the particles (i.e., the coating particles may not heat sufficiently prior to depositing on the surface of the substrate 1150 because of decreased dwell time). In this manner, the gas sheath 1110 can allow sufficient penetration of the liquid suspension 1130 into the plasma 1119 at the desired reduced mass flow rate.

FIG. 12 shows yet another variation for providing a sheath around the injection point for the liquid suspension. In particular, FIG. 12 shows a SPS system and process 1200 in which a gas sheath 1210 envelopes the liquid suspension 1230 at its injection location. The gas sheath 1210 radially extends around the liquid suspension 1230 at a location external to the nozzle 1280. Primary torch gas 1220 axially flows within the nozzle 1180 and ionizes into a plasma 1219 upon contacting an arc generated by cathode 1282 and anode 1281. The liquid suspension 1230 is injected into the plasma effluent 1240 as it emerges from the outlet of the nozzle 1280. The injection occurs at an orthogonal orientation with respect to the axis of the plasma effluent 1240. However, it should be understood that the angle of injection of the liquid suspension 1230 relative to the plasma effluent 1240 may be varied as contemplated by the present invention. Similar to FIG. 11, the gas sheath 1210 can impart the necessary momentum to the liquid suspension 1230 to enable its injection into the turbulent plasma effluent without the need for increasing the velocity of the liquid suspension 1230 at the injection location. By not being susceptible to particle ejection, the effluent 1240 upon emerging from the outlet of the nozzle 1080 can maintain a flow path trajectory directed towards the surface of the substrate 1250 where the coating particles deposit as coating 1260.

FIG. 12 shows that utilizing a gas shroud or gas sheath 1210 adjacent to or surrounding the liquid suspension 1230 at or near the point of injection tends to fragment the liquid suspension droplets 1230 prior to introduction of the suspension 1230 into the plasma effluent 1240. This fragmentation is illustrated at region 1231. By fragmenting the droplets prior to injection into the plasma effluent 1240, the gas sheath 1210 can aid in the control of the droplet size and droplet size distribution of the liquid suspension 1230 being injected into the plasma effluent 1240. In this manner, there may be less fragmentation occurring in the plasma effluent 1240 and droplet size and droplet size distribution will be generally independent of spatial and temporal changes occurring as the plasma effluent 1240 moves toward the substrate surface 1250 to be coated. In other words, the average droplet size and droplet size distribution is more precisely and reproducibly controlled resulting in improved plasma spray process control and improved coating microstructures.

The benefits arising from shrouding the effluent, as explained in FIGS. 4-9, may also occur as a result of using the gas sheaths at or near the injection point for the liquid suspension as shown in FIGS. 10-12. Furthermore, providing a gas sheath proximate the suspension injection can provide kinetic energy at the effluent boundary to aid in re-entraining particles ejected from the effluent due to turbulent flow within the effluent.

In some applications, the gas sheath may be a heated gas that evaporates or partially evaporates the liquid carrier to further control droplet fragmentation and the average droplet size of liquid suspension droplets injected into the plasma effluent. In applications where a significant evaporation of the liquid carrier occurs as a result of the heated gas sheath, the liquid carrier would be evaporated and the remaining solid particles would be injected directly into the plasma effluent.

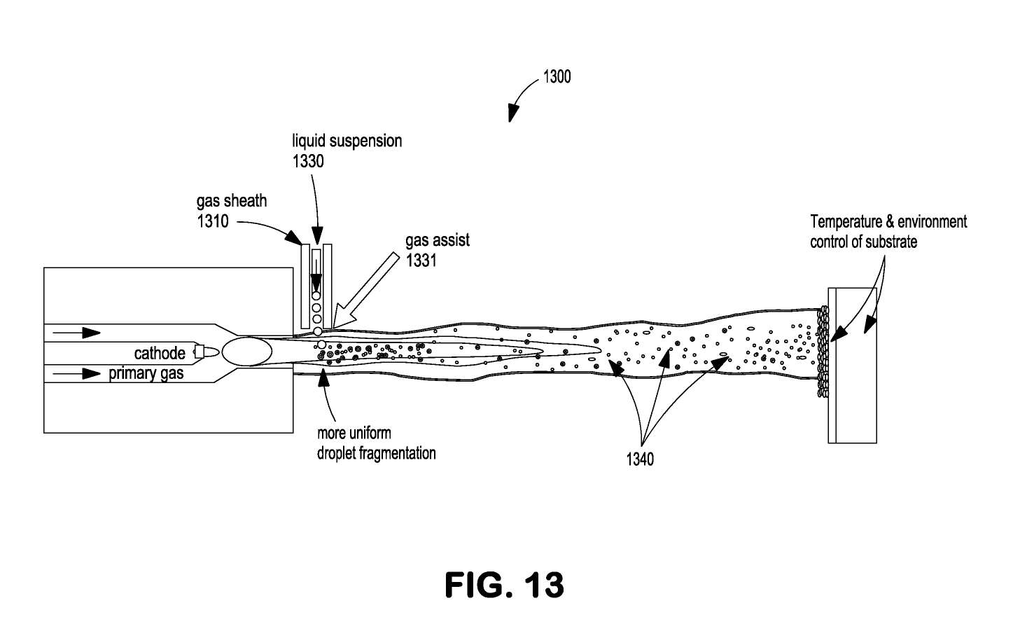

Turning now to FIG. 13, there is shown a schematic illustration of another embodiment of the present suspension plasma spray system and process 1300 employing an external radial injection of the liquid suspension 1330 with a gas assist stream 1331 employed at or near the injection point for the suspension 1330. The gas assist stream 1331 is an alternative to or complimentary to a full gas shroud or gas sheath surrounding the suspension 1330. The gas assist stream 1331 is preferably a single or dual stream of gas injected proximate to and contemporaneously with the suspension injection and preferably at a prescribed offset angle from the liquid suspension injection 1330. The gas assist stream 1331 can function to assist in the droplet fragmentation and control of the average droplet size prior to entry of the droplets of liquid suspension 1330 into the plasma effluent 1340, or in cases where the gas assist stream 1331 is a reactive gas, the stream 1331 supplements the combustion and/or chemical reactions occurring in the plasma effluent or both. For example, the gas assist stream 1331 can be used to aid in the formation of carbides, nitrides or oxides of the particles at the point of injection into the plasma effluent.

It should be appreciated that the gas assist feature 1331 described above can be used in conjunction with the gas sheath 1310, as illustrated in FIG. 13, or in lieu of the gas sheath 1310. Also, the gas assist feature 1331 can be equally applied to suspension plasma spray systems utilizing internal radial injection configurations, external radial injection configurations and axial injection configurations.

Utilization of the gas shroud, gas sheath or gas assist stream during a suspension plasma spray process requires control of the gas flow. The most likely flow characteristics of the gas shroud, gas sheath or gas assist stream to be controlled include the volumetric flow rate, velocity, and gas orientation relative to the injection of the liquid suspension. The exact or preferred orientations, flow rates, velocities relative to the injection of the liquid suspension depends on the type of gas or gas mixture as well as the desired effects of the gas shroud, gas sheath or gas assist stream. For example, if the purpose of the gas shroud is to promote droplet fragmentation only, it may be advantageous to use a high velocity inert shroud gas. On the other hand, if the intended effect of the gas shroud or gas sheath is strictly to enhance the particle entrainment and promote the combustion or chemical reactions in the plasma effluent, a laminar flow of oxygen or other reactive gas may be used for the gas shroud. Adjustment and control of these gas shroud flow characteristics are often dictated by the geometry and configuration of the nozzles or injection devices as well as the gas supply pressures and temperatures.

In another example to illustrate selection of the appropriate SPS system and process of the present invention, where the carrier liquid of the suspension is a combustible fuel, such as ethanol, an inert gas shroud is preferably employed as described and illustrated in FIGS. 7-9. The inert gas shroud is arranged to directly control the degree and location of atmospheric mixing. In such cases, it is not the objective of the inert gas shroud to prevent or inhibit effluent interactions with the surrounding atmosphere, but rather to selectively and controllably introduce atmospheric mixing into the plasma effluent, and precisely control the degree of effluent interactions with the surrounding atmosphere. The flow rate and orientation of the inert gas shroud are tailored to allow atmospheric infiltration, and in particular oxygen infiltration, at the appropriate locations and desired concentrations to optimize the combustion of the flammable carrier medium. In one example, a preferred means to achieve or affect this control is the use of partial inert gas shrouds as illustrated in FIG. 7. One can tailor the angle of convergence of divergence of the shroud to select the distance of shroud interaction with the effluent to attain selective atmospheric interaction with the effluent.

In situations where it is desirable to use the inert gas shroud to prevent or inhibit effluent interactions with the surrounding atmosphere, there is a further synergistic benefit associated with the inert gas shroud. In particular, the flow characteristics of the inert gas shroud are controlled to effect control of the degree of evaporation of the liquid carriers from the effluent stream prior to combustion and thereby delay or otherwise optimize the combustion process occurring within the effluent stream. Controlling the evaporation of the liquid may also prove beneficial in coatings where presence of oxygen is not desired in the deposited coating or in SPS coating applications where excessive combustion serves to, for example, either further fragment liquid droplets to a size that is undesirable, or introduce additional heat into the substrate due to the exothermic reaction of the combustion.

Conversely, control of immediate and full combustion of flammable species of the liquid carriers through control of the flow characteristics and profile of the inert gas shroud may also prove beneficial where the deposited coatings includes targeted oxides and or further fragmentation of liquid droplets is desirable.

It is to be noted that the present invention is capable of depositing a wide array of fine particulate sizes in the sub-micron range, previously not possible by coating technologies, including that of conventional plasma spraying. For example, in one embodiment, the SPS system and process of the present invention can deposit coating particulates in a size range from 100 nm to 1 μm. In another embodiment, the present invention can deposit coating particulates 1 μm or lower, without incurring undesirable agglomeration of the fine particulates as typically encountered in conventional spray systems and processes.

As indicated above, the typical reactive gases used for the reactive gas shroud include, but are not limited to, oxygen, hydrogen, carbon dioxide; hydrocarbon fuels, and nitrogen or combinations or combinations thereof.

Advantageously, the SPS system described herein can be prepared utilizing suitable torch and nozzle assemblies that are commercially available, thus enabling and simplifying the overall fabrication process. Aspects of plasma generation can be carried out using standard techniques or equipment.

Any suitable liquid suspension delivery subsystem can be employed for delivering a flow of the liquid suspension with sub-micron particles dispersed therein to the plasma. The liquid suspension source is a dispenser for the liquid suspension. The source typically includes a reservoir, transport conduit (e.g., tubing, valving, and the like), and an injection piece (e.g., nozzle, atomizer and the like). In addition, the liquid suspension delivery subsystem may contain measurement feedback of the process (e.g., flow rate, density, temperature) and control methods such as, for example, pumps and actuators that can work in conjunction or independently from one another. The system may also contain additional flushing or cleaning systems, mixing and agitation systems, heating or cooling systems as known in the art.

From the foregoing, it should be appreciated that the present invention thus provides a system and method for shrouded suspension plasma sprays. While the invention herein disclosed has been described by means of specific embodiments and processes associated therewith, numerous modifications and variations can be made thereto by those skilled in the art without departing from the scope of the invention as set forth in the claims or sacrificing all of its features and advantages.

What is claimed is:

1. A thermal spray system for producing coatings on a substrate from a liquid suspension comprising:
a thermal spray torch for generating a plasma;
a liquid suspension delivery subsystem for delivering a flow of the liquid suspension with sub-micron particles; and
a nozzle assembly for delivering the plasma from the thermal spray torch to the liquid suspension to produce a plasma effluent, the nozzle assembly adapted for producing an inert gas shroud substantially surrounding said plasma effluent;
wherein the inert shroud is configured to substantially retain entrainment of the sub-micron particles in the plasma effluent and substantially inhibit gases from entering and reacting with the plasma effluent.

2. The thermal spray system of claim 1, wherein the shroud extends from the nozzle assembly to the substrate surface.

3. The thermal spray system of claim 1, wherein the shroud is a laminar flowing shield.

4. The thermal spray system of claim 1, wherein the shroud has an axial distance less than a distance from the nozzle to the substrate surface.

5. The thermal pray system of claim 4, wherein the shroud diverges in a direction towards the substrate.

6. The thermal pray system of claim 4, wherein the shroud converges in a direction towards the substrate.

7. The thermal spray system of claim 1, wherein the liquid suspension delivery subsystem comprises an injector adapted to produce an inert or reactive gas sheath surrounding the flow of the liquid suspension.

8. The thermal spray system of claim 1, wherein the liquid suspension system is configured external to the nozzle.

9. The thermal spray system of claim 1, wherein the liquid suspension system is configured internal to the nozzle.

10. The thermal spray system of claim 1, wherein the liquid suspension system is configured internal to the nozzle so as to deliver an axial flow of the liquid suspension.

11. The thermal spray system of claim 8, wherein the liquid suspension system further comprises a gas assist stream proximate to and contemporaneously with the liquid suspension system.

12. A method of producing coatings on a substrate using a liquid suspension with sub-micron particles dispersed therein, the method comprising the steps of:
generating a plasma from a thermal spray torch;
delivering a flow of liquid suspension with sub-micron particles dispersed therein to the plasma or in close proximity thereto to produce a plasma effluent stream;
surrounding the flow of the effluent stream with an inert gas shroud to produce a shrouded effluent;
retaining the sub-micron particles entrained within the shrouded effluent; and
directing the shrouded effluent with the sub-micron particles contained therein towards the substrate to coat the substrate.

13. The method of claim 12, further comprising the step of—substantially preventing entrainment of gases into the shrouded effluent.

14. The method of claim 12, further comprising the step of fragmenting droplets of the liquid suspension across the shroud.

15. The method of claim 12, further comprising the steps of:
selectively removing the shroud at a predetermined axial distance away from the substrate surface;
introducing ambient gases at the predetermined axial distance and downstream thereof;
oxidizing a portion of the sub-micron particles.

16. The method of claim 15, further comprising the step of converging the shroud at the predetermined axial distance.

17. The method of claim 15, further comprising the step of diverging the shroud away from the effluent stream to allow the introduction of ambient gases at the predetermined axial distance.

18. The method of claim 12, further comprising the step of surrounding the liquid suspension with a gas sheath.

19. The method of claim 18, further comprising the step of introducing a stream of gas injected proximate to and contemporaneously with the suspension injection.

20. The method of claim 18, wherein the sub-micron particles have an average particle size of 10 microns lower.

21. A coating deposited on the substrate prepared according to the process of claim 12.
